(19) United States
(12) Patent Application Publication
(10) Pub. No.: US 2024/0010242 A1
(43) Pub. Date: Jan. 11, 2024

(54) SIGNAL PROCESSING DEVICE AND SIGNAL PROCESSING METHOD

(71) Applicant: SONY SEMICONDUCTOR SOLUTIONS CORPORATION, KANAGAWA (JP)

(72) Inventor: SATOSHI NAKAYAMA, KANAGAWA (JP)

(21) Appl. No.: 18/251,711

(22) PCT Filed: Oct. 28, 2021
(86) PCT No.: PCT/JP2021/039814

§ 371 Date: May 3, 2023

(30) Foreign Application Priority Data
Nov. 11, 2020 (JP) 2020-187907

(51) Int. Cl. B60W 60/00; G06V 20/56; G06T 7/246

(52) U.S. Cl. CPC B60W 60/005; G06V 20/588; G06T 7/248; B60W 2420/42; G06T 2207/30256; G06T 2207/30261

(57) ABSTRACT

A signal processing device (e.g., imaging device 10) according to one aspect of present disclosure includes: an image comparison unit (14) that acquires difference information between first free space on a road, in which a vehicle travels, in a first image and second free space on the road in a preliminarily obtained second image; and a control unit (16) that controls an automated driving level of the vehicle based on the difference information.

### FIELD

The present disclosure relates to a signal processing device and a signal processing method.

### BACKGROUND

In recent years, development of automated driving technology has been accelerated. For example, there has been developed a lane recognition system capable of inhibiting erroneous recognition of the position and direction of a host vehicle to a lane by comparing an image including a dividing line generated by simulation based on map data with an image including a dividing line of the current position (e.g., see Patent Literature 1).

### CITATION LIST

### Patent Literature

Patent Literature 1: JP 2016-162260 A

### SUMMARY

### Technical Problem

In the above-described lane recognition system, however, when an object such as another vehicle and an obstacle is placed on a road, it is not considered to distinguish the object and the line in an image from each other, and the position and direction of a host vehicle to the lane may be erroneously recognized. The occurrence of the erroneous recognition makes it difficult to appropriately perform control related to automated driving.

Therefore, the present disclosure provides a signal processing device and a signal processing method capable of appropriately performing control related to automated driving.

### Solution to Problem

A signal processing device according to one aspect of present disclosure includes: an image comparison unit that acquires difference information between first free space on a road, in which a vehicle travels, in a first image and second free space on the road in a preliminarily obtained second image; and a control unit that controls an automated driving level of the vehicle based on the difference information.

### BRIEF DESCRIPTION OF DRAWINGS

FIG. 1 is a block diagram illustrating an example of a schematic configuration of an imaging device according to a first embodiment.

FIG. 2 is an explanatory view for illustrating processing of generating an overhead image according to the first embodiment.

FIG. 3 is an explanatory view illustrating measurement points according to the first embodiment.

FIG. 4 is a flowchart illustrating a flow of automated driving processing according to the first embodiment.

FIG. 5 is a block diagram illustrating a flow of image comparison processing according to the first embodiment.

FIG. 6 is an explanatory diagram for illustrating the image comparison processing according to the first embodiment.

FIG. 7 is a flowchart illustrating a flow of situation analysis processing according to the first embodiment.

FIG. 8 is an explanatory diagram for illustrating a first example of situation analysis according to the first embodiment.

FIG. 9 is an explanatory diagram for illustrating a second example of the situation analysis according to the first embodiment.

FIG. 10 is an explanatory diagram for illustrating a third example of the situation analysis according to the first embodiment.

FIG. 11 is an explanatory diagram for illustrating a fourth example of the situation analysis according to the first embodiment.

FIG. 12 is an explanatory diagram for illustrating a fifth example of the situation analysis according to the first embodiment.

FIG. 13 is an explanatory diagram for illustrating a first example of recognition inability according to the first embodiment.

FIG. 14 is an explanatory diagram for illustrating a second example of the recognition inability according to the first embodiment.

FIG. 15 is a flowchart illustrating a flow of image selection processing according to the first embodiment.

FIG. 16 is an explanatory diagram for illustrating one example of image selection according to the first embodiment.

FIG. 17 is an explanatory view for illustrating another example of free space detection according to the first embodiment.

FIG. 18 is a block diagram illustrating an example of a schematic configuration of an imaging system according to a second embodiment.

FIG. 19 is a block diagram illustrating an example of a schematic configuration of an imaging system according to a third embodiment.

### DESCRIPTION OF EMBODIMENTS

Embodiments of the present disclosure will be described in detail below with reference to the drawings. Note that, in the following embodiments, the same reference signs are attached to the same parts, so that duplicate description will be omitted.

Furthermore, the present disclosure will be described in accordance with the following item order.

1. First Embodiment

1-1. Example of Schematic Configuration of Imaging Device

1-2. Processing of Generating Overhead Image

1-3. Measurement Points (Image Acquisition Points)

1-4. Automated Driving Processing

1-5. Image Comparison Processing

1-6. Situation Analysis Processing

1-7. Processing of Controlling Automated Driving Level

1-8. Image Selection Processing

1-9. Actions/Effects

2. Second Embodiment

3. Third Embodiment

4. Other Embodiments

5. Appendix

### 1. First Embodiment

<1-1. Example of Schematic Configuration of Imaging Device>

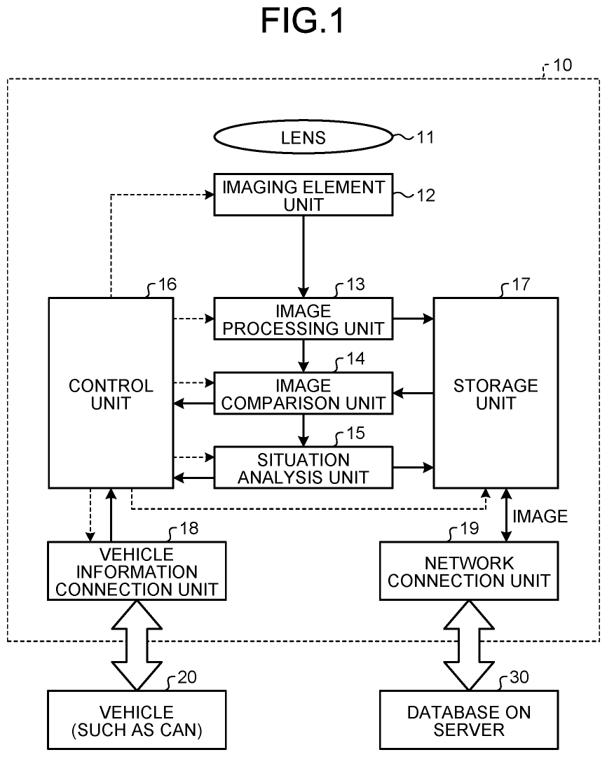

An example of a schematic configuration of an imaging device 10 according to a first embodiment, to which a signal processing device according to the present disclosure is applied, will be described with reference to FIG. 1. FIG. 1 is a block diagram illustrating the example of the schematic configuration of the imaging device 10 according to the first embodiment.

As illustrated in FIG. 1, the imaging device 10 includes an optical system 11, an imaging element unit 12, an image processing unit 13, an image comparison unit 14, a situation analysis unit 15, a control unit 16, a storage unit 17, a vehicle information connection unit 18, and a network connection unit 19. The imaging device 10 is connected to a vehicle 20 via the vehicle information connection unit 18, and is also connected to a database 30 on a server via the network connection unit 19.

The optical system 11 includes one or a plurality of lenses. The optical system 11 guides light (incident light) from a subject to the imaging element unit 12, and forms an image on a light receiving surface of the imaging element unit 12.

The imaging element unit 12 includes a plurality of pixels each including a light receiving element. These pixels are arranged in, for example, a two-dimensional lattice pattern (matrix pattern). The imaging element unit 12 performs imaging under exposure control performed by the control unit 16, and transmits exposure data to the image processing unit 13. For example, a complementary metal oxide semiconductor (CMOS) image sensor and a charge coupled device (CCD) image sensor are used as the imaging element unit 12.

The image processing unit 13 receives the exposure data from the imaging element unit 12. The image processing unit 13 performs image processing based on the exposure data in accordance with a processing instruction from the control unit 16. For example, the image processing unit 13 generates various images such as an overhead image from the exposure data. The image processing unit 13 transmits various images (image data) such as the overhead image to the storage unit 17.

In accordance with a comparison instruction from the control unit 16, the image comparison unit 14 compares images by using image data generated by the image processing unit 13 and image data read from the storage unit 17. The image comparison unit 14 transmits a comparison result based on each piece of image data to the control unit 16, the situation analysis unit 15, and the like.

In accordance with an analysis instruction from the control unit 16, the situation analysis unit 15 analyzes a situation based on the comparison result transmitted from the image comparison unit 14. For example, the situation analysis unit 15 analyzes a situation (state) of the vehicle 20 in accordance with a displacement amount from a design position (predetermined installation position) of the imaging device 10 and the like. The situation analysis unit 15 transmits an analysis result for the situation of the vehicle 20 to the control unit 16, the storage unit 17, and the like.

The control unit 16 issues an instruction to each of the imaging element unit 12, the image processing unit 13, the image comparison unit 14, the situation analysis unit 15, the storage unit 17, and the like, and controls each of these units. Furthermore, the control unit 16 transmits data of an analysis result notification, an automated driving level instruction, and the like to the vehicle 20 via the vehicle information connection unit 18. The control unit 16 receives travel data (one example of vehicle information) from the vehicle 20 via the vehicle information connection unit 18. The control unit 16 transmits a server access instruction to the storage unit 17. For example, a processor such as a central processing unit (CPU) is used as the control unit 16. The CPU includes a read only memory (ROM), a RAM, and the like. The CPU controls an operation of each unit by using the RAM as a work memory in accordance with a program preliminarily stored in the ROM.

The storage unit 17 stores various pieces of data such as image data. For example, a non-volatile memory such as a flash memory and a hard disk drive is used as the storage unit 17. In response to a server access instruction from the control unit 16, the storage unit 17 transmits and receives various pieces of data to and from the server, that is, the database 30 on the server via the network connection unit 19.

The vehicle information connection unit 18 enables transmission and reception of various pieces of data (e.g., vehicle information, analysis result notification, and automated driving level instruction) to and from the vehicle 20 in accordance with a communication standard such as a controller area network (CAN). For example, various communication interfaces (I/F) compliant with the CAN and the like are used as the vehicle information connection unit 18.

The network connection unit 19 enables transmission and reception of various pieces of data (e.g., image data) to and from the database 30 on the server in accordance with various communication standards. For example, various communication I/Fs compliant with a wireless wide area network (WAN) and the like are used as the network connection unit 19.

The vehicle 20 is connected to the imaging device 10 via the vehicle information connection unit 18. The vehicle 20 transmits and receives various pieces of data to and from the control unit 16 via the vehicle information connection unit 18. For example, the vehicle 20 transmits various pieces of data such as vehicle information (e.g., travel data) to the control unit 16, and receives various pieces of data of an analysis result notification, an automated driving level instruction, and the like from the control unit 16.

The database 30 is connected to the imaging device 10 via the network connection unit 19. The database 30 is, for example, provided on a server connected to a communication network such as a network, and stores and manages various pieces of data. For example, the database 30 receives and stores various pieces of data such as image data from the storage unit 17.

Note that each unit such as the image processing unit 13, the image comparison unit 14, the situation analysis unit 15, and the control unit 16 described above may be configured by both or any one of hardware and software, and the configurations thereof are not particularly limited.

<1-2. Processing of Generating Overhead Image>

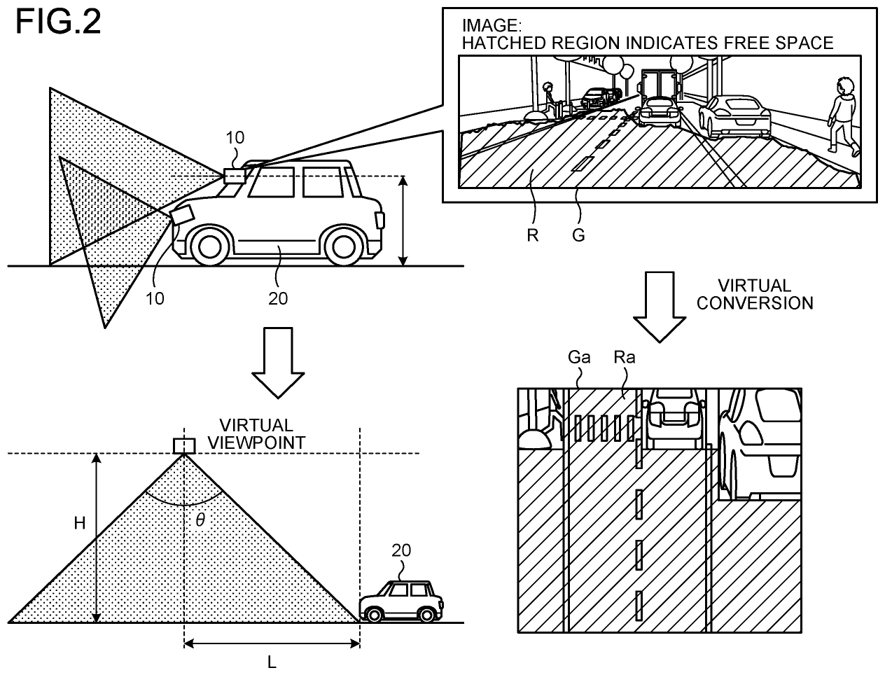

Processing of generating an overhead image according to the first embodiment will be described with reference to FIG. 2. FIG. 2 is an explanatory view for illustrating the processing of generating an overhead image according to the first embodiment.

As illustrated in FIG. 2, the imaging device 10 is provided on, for example, an upper portion of a windshield in a vehicle interior of the vehicle 20 or a front portion of the vehicle 20. The imaging device 10 faces the front of the vehicle 20, which is a host vehicle. The imaging device 10 is mainly used to detect a preceding vehicle, a pedestrian, a road, a lane, a road surface sign, an obstacle, a traffic light, a traffic sign, and the like. The imaging device 10 is, for example, a wide-angle camera.

As illustrated in FIG. 2, the imaging device 10 images the front of the vehicle 20 to obtain an image G. The obtained image G includes an object (subject) such as another vehicle and an obstacle. Free space R (hatched region in image G in FIG. 2) is provided on a road while avoiding the region of the object. The free space R is a travelable region/region to be traveled without the object such as another vehicle and an obstacle. The free space R may be a plane region on a road or a space region on the road.

Virtual transformation is performed on the above-described image G to generate an overhead image Ga based on a virtual viewpoint. The image processing unit 13 detects free space Ra (hatched region in overhead image Ga in FIG. 2) corresponding to the above-described free space R from the overhead image Ga. For example, an area on a road in front of the vehicle 20 is detected as the free space Ra by image processing while an object such as another vehicle and an obstacle is avoided. Note that image comparison is made possible between vehicles having different attachment positions of the imaging device 10 by using the overhead image Ga obtained by fixing a virtual viewpoint.

<1-3. Measurement Points (Image Acquisition Points)>

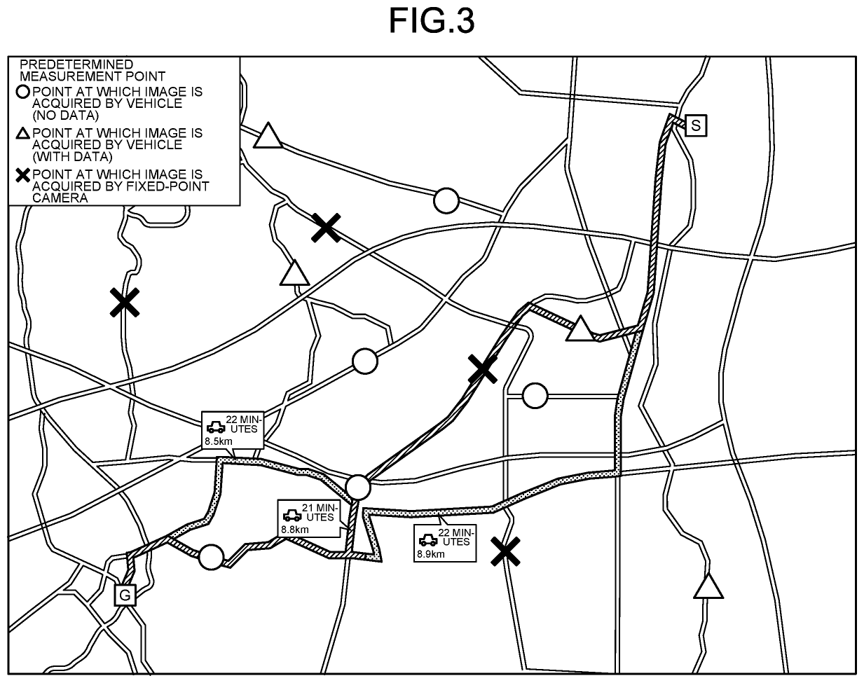

Measurement points (image acquisition points) according to the first embodiment will be described with reference to FIG. 3. FIG. 3 is an explanatory view illustrating the measurement points according to the first embodiment. The measurement points are image acquisition points at which an image is acquired.

As illustrated in FIG. 3, measurement points (see Δ, ◯, and X marks in FIG. 3) are set on a map. The measurement points include a point at which an image is acquired by the vehicle 20 (no data), a point at which an image is acquired by the vehicle 20 (with data), and a point at which an image is acquired by a fixed-point camera. The point at which an image is acquired by the vehicle 20 (no data) is a measurement point at which the vehicle 20 acquires an image without data (pre-captured image) for the measurement point. The point at which an image is acquired by the vehicle 20 (with data) is a measurement point at which the vehicle 20 acquires an image with data (pre-captured image) for the measurement point. The point at which an image is acquired by a fixed-point camera is a measurement point at which the fixed-point camera acquires an image.

Such measurement points are preset along roads on the map. Setting point information indicating the measurement points is stored in, for example, the database 30 or the like, and is appropriately read and used by the vehicle 20 or the imaging device 10. Note that the measurement point information may be read by any one of the vehicle 20 and the imaging device 10, and may be transmitted from one that has read the information to the other that has not read the information.

For example, when a start (current location) and a goal (destination) are set on the map, the vehicle 20 automatically sets routes (routing). In one example, the routes are set in ascending order of travel times and travel distances. In the example of FIG. 3, three routes are set. Thereafter, a driver or the like selects one route. Automated driving is started at an automated driving level suitable for the route. Then, the vehicle 20 travels along the route. Note that the automated driving level will be described later in detail.

The imaging device 10 appropriately captures an image at a measurement point based on the measurement point information. The imaging device 10 can acquire vehicle information (e.g., position information of vehicle 20) from the vehicle 20, and recognize the position of the vehicle 20. Usually, the imaging device 10 performs imaging in real time. When the vehicle 20 reaches a measurement point, the imaging device 10 captures and acquires a host vehicle image at the measurement point. Furthermore, the imaging device 10 preliminarily reads a pre-captured image for a measurement point from the database 30 at the timing when the vehicle 20 approaches the measurement point (position at predetermined distance to measurement point). The imaging device 10 compares the preliminarily read pre-captured image with the host vehicle image acquired at the measurement point. For example, since the pre-captured image is converted into an overhead image and stored in the database 30, the host vehicle image is also converted into an overhead image by the above-described processing of generating an overhead image to perform the above-described comparison.

Here, the host vehicle image (first image) is obtained by the imaging device 10 provided on the vehicle 20 currently traveling on the route. In contrast, the pre-captured image (second image) is stored in the database 30, and preliminarily obtained before the host vehicle image is obtained (e.g., pre-captured image captured by the imaging device 10 or fixed-point camera). Furthermore, the vehicle information includes various types of information on the vehicle 20, and includes, for example, information on movement of the vehicle 20 such as the position, speed, acceleration, angular speed, traveling direction, and the like of the vehicle 20. The position of the vehicle 20 is measured by, for example, a positioning system in which a satellite navigation system such as a global navigation satellite system (GNSS) that measures the current position by using an artificial satellite, an altimeter, an acceleration sensor, and a gyroscope are combined.

Note that, when the pre-captured image for the above-described measurement point is not stored in the database 30, the host vehicle image acquired at the measurement point is stored in the storage unit 17 in association with the measurement point. The host vehicle image (image data) is transmitted from the imaging device 10 to the database 30. The database 30 receives the host vehicle image transmitted from the imaging device 10, and stores and manages the host vehicle image as a pre-captured image.

<1-4. Automated Driving Processing>

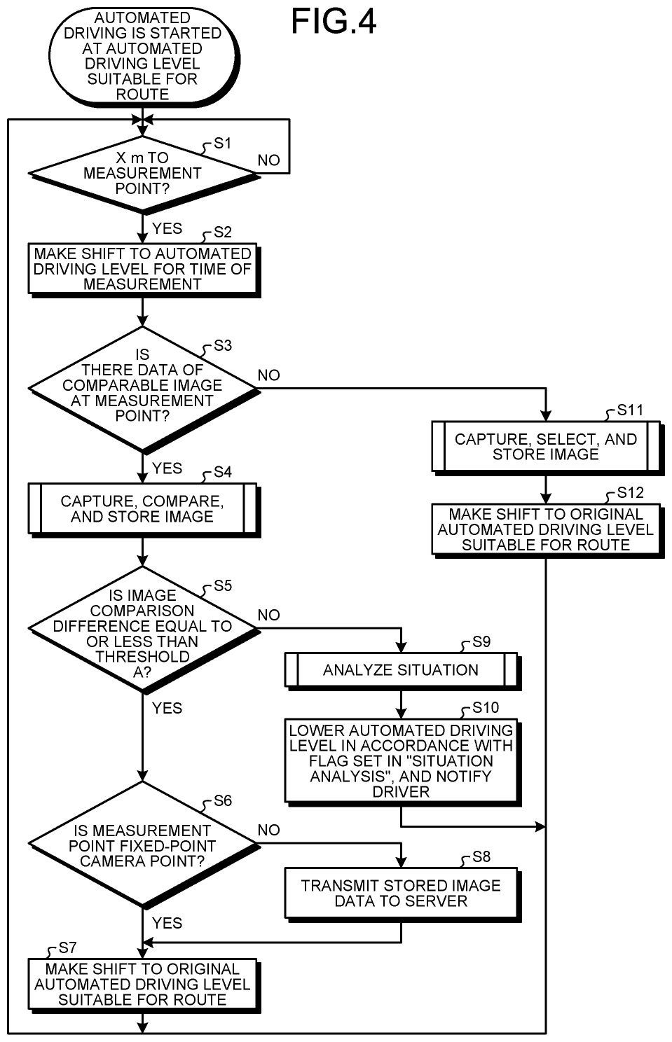

Automated driving processing according to the first embodiment will be described with reference to FIG. 4. FIG. 4 is a flowchart illustrating a flow of the automated driving processing according to the first embodiment.

As illustrated in FIG. 4, automated driving is started at an automated driving level suitable for a route. The control unit 16 determines whether or not the vehicle 20 is at a predetermined distance Xm to a measurement point (Step S1), and waits until the vehicle 20 is at the predetermined distance Xm to the measurement point (NO in Step S1). The control unit 16 recognizes the position of the vehicle 20 from vehicle information obtained from the vehicle 20.

When determining that the vehicle 20 is at the predetermined distance Xm to the measurement point (YES in Step S1), the control unit 16 shifts the current automated driving level to a measurement automated driving level (Step S2). That is, automated driving (execution) at the measurement automated driving level is permitted. At the measurement automated driving level, the vehicle 20 is controlled based on automated driving information such as the speed and position of the vehicle 20 suitable for measurement. This allows the imaging device 10 to perform imaging under a condition suitable for measurement, so that an accurate host vehicle image can be obtained.

The control unit 16 determines whether or not there is data of a comparable image (pre-captured image) at the measurement point (Step S3). When the control unit 16 determines that there is data of a comparable image at the measurement point (YES in Step S3), the image processing unit 13 and the image comparison unit 14 capture, compare, and store the image (Step S4). Note that the processing of Step S4 will be described later in detail.

The control unit 16 determines whether or not an image comparison difference (difference amount) is equal to or less than a predetermined threshold A (Step S5). When determining that the image comparison difference is equal to or less than the predetermined threshold A (YES in Step S5), the control unit 16 determines whether or not the measurement point is a fixed-point camera point (point at which image is acquired by fixed-point camera) (Step S6).

When determining that the measurement point is the fixed-point camera point (YES in Step S6), the control unit 16 shifts the current automated driving level to an original automated driving level suitable for the route (Step S7). That is, automated driving at the original automated driving level is permitted. In contrast, when determining that the measurement point is not the fixed-point camera point (NO in Step S6), the control unit 16 transmits the stored image data to the server (Step S8). The server stores the stored image data in the database 30.

When the control unit 16 determines, in Step S5 described above, that the image comparison difference is not equal to or less than the predetermined threshold A (NO in Step S5), the situation analysis unit 15 analyzes a situation in relation to the situation of the host vehicle (Step S9). The control unit 16 lowers the current automated driving level in accordance with a flag set in the situation analysis, and notifies a driver (Step S10). That is, automated driving at the current automated driving level is prohibited. Note that the processing of Step S9 will be described later in detail.

When the control unit 16 determines, in Step S3 described above, that there is not data of a comparable image at the measurement point (NO in Step S3), the image processing unit 13 and the image comparison unit 14 capture, select, and store the image (Step S11). The control unit 16 shifts the current automated driving level to the original automated driving level suitable for the route (Step S12). That is, automated driving at the original automated driving level is permitted. Note that the processing of Step S11 will be described later in detail.

Here, in Step S3, even if the database 30 has an image (pre-captured image) for the measurement point, the image is not necessarily a comparable image. For example, it is difficult to obtain an accurate comparison result even if a daytime image (pre-captured image) of the measurement point is compared with an image (host vehicle image) acquired during nighttime driving. Therefore, when storing an image in the database 30 on the server, the imaging device 10 stores incidental information related to the image together with the image in association with the image. The incidental information includes exposure information (e.g., environmental illuminance, gain value, and histogram) of an image, the date and time when the image was captured, and a type of a vehicle that acquired the image.

The control unit 16 determines whether or not there is a comparable image based on the incidental information associated with the image (pre-captured image). For example, in Step S3, when the difference between the environmental illuminance of an image to be compared and the environmental illuminance acquired by a host vehicle camera (imaging device 10) immediately before image acquisition is equal to or less than a certain predetermined value, the control unit 16 determines that there is data of a comparable image.

Furthermore, when a time zone of capturing the image to be compared is the same as a time zone (around sunrise, daytime, around sunset, and nighttime) of capturing performed by the host vehicle camera immediately before image acquisition, or when an attachment condition (attachment position and vignetting by vehicle body) of the host vehicle camera is close (e.g., when type of vehicle 20 is same as type of another vehicle that acquired pre-captured image), the control unit 16 determines that there is the data of the comparable image. Furthermore, when the date of capturing the image to be compared is within a certain period and after the date on which a condition change near the measurement point occurred, the control unit 16 determines that there is the data of the comparable image. The above-described date when the condition change near the measurement point occurred is the date and time when, for example, construction and a change in a road surface sign can be grasped, that is, the date and time when the construction and the change in a road surface sign have been later determined by detecting a difference in automated driving processing.

Note that, although the above-described various pieces of information are individually used here, this is not a limitation. Each condition may be given a score by weighting each condition based on the various pieces of information. In this case, the control unit 16 may select and use image data most suitable for comparison in accordance with the score, or may use a plurality of pieces of image data with a certain score or more as comparison targets.

<1-5. Image Comparison Processing>

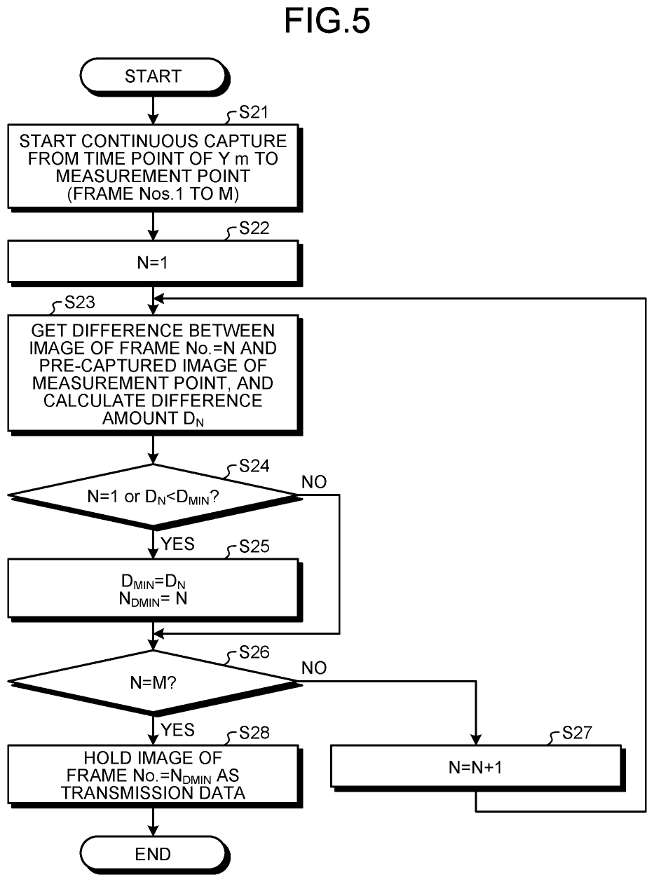

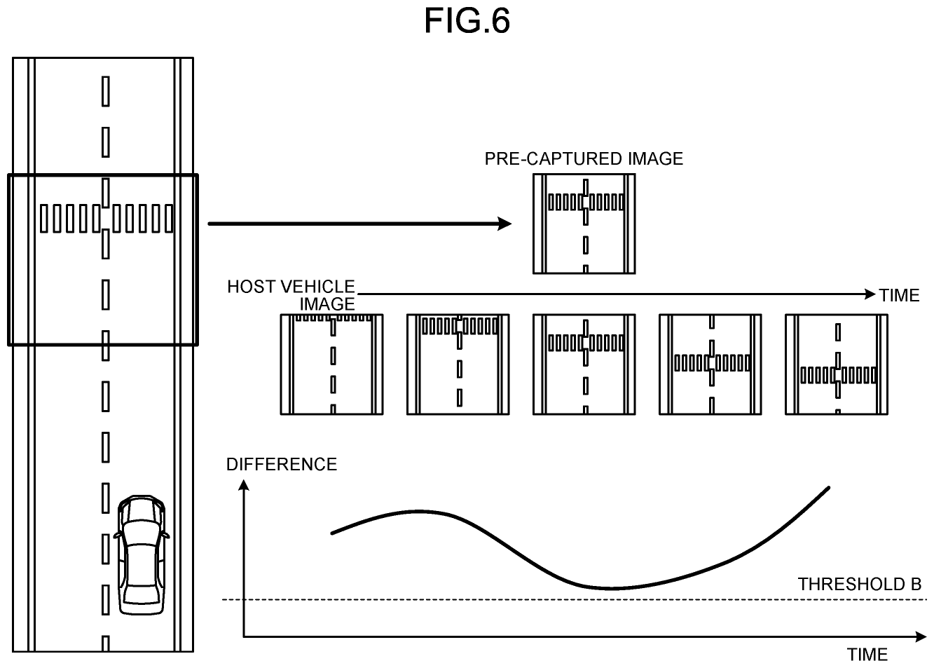

Image comparison processing according to the first embodiment will be described with reference to FIGS. 5 and 6. FIG. 5 is a flowchart illustrating a flow of the image comparison processing according to the first embodiment. The image comparison processing corresponds to the processing of Step S4 during the automated driving processing in FIG. 4. FIG. 6 is an explanatory diagram for illustrating the image comparison processing according to the first embodiment.

As illustrated in FIG. 5, the image processing unit 13 starts continuous capture of a host vehicle image from a time point when the vehicle 20 is at a predetermined distance Ym to a measurement point (Step S21), and sets N=1 (Step S22). The number of frames is M (frame Nos. 1 to M).

The image comparison unit 14 gets the difference between an image (host vehicle image) of frame No.=N and a pre-captured image of a measurement point, and calculates a difference amount D_{N} (Step S23). The difference amount D_{N} is one example of difference information.

The image comparison unit 14 determines whether or not N=1 or D_{N}<D_{MIN} is established (Step S24). When determining that N=1 or D_{N}<D_{MIN} is established (YES in Step S24), the image comparison unit 14 sets D_{MIN}=D_{N} and N_{DMIN}=N (Step S25), and advances the processing to Step S26. In contrast, when determining that N=1 or D_{N}<D_{MIN} is not established (NO in Step S24), the image comparison unit 14 advances the processing straight to Step S26.

The image comparison unit 14 determines whether or not N=M is established (Step S26). When determining that N=M is not established (NO in Step S26), the image comparison unit 14 sets N=N+1 (Step S27), and returns the processing to Step S23. In contrast, when determining that N=M is established (YES in Step S26), the image comparison unit 14 holds an image of frame No.=N_{DMIN} as transmission data (Step S28).

For example, as illustrated in FIG. 6, a pre-captured image of a measurement point is read. In the example of FIG. 6, five (frame Nos. 1 to 5: M=5) host vehicle images are acquired by continuous capture of a host vehicle image. The difference amount D_{N}, which is an amount of difference between these host vehicle images and the pre-captured image is determined. An image having the minimum difference amount D_{N} (central host vehicle image among host vehicle images in FIG. 6) is held as the transmission data. This allows the image having the minimum difference amount D_{N} to be used for image comparison as the host vehicle image.

Note, however, that, when a minimum difference amount D_{MIN} is larger than a predetermined threshold B as illustrated in FIG. 6, it is considered that an abnormality has occurred. In response to the abnormality occurrence, for example, the control unit 16 may issue an instruction to the vehicle 20 to reduce the speed of the vehicle 20 or increase a following distance of the vehicle 20. Thereafter, the control unit 16 may shift the image comparison processing to abnormality determination processing, for example. The threshold B in FIG. 6 is merely an example, and an image in which the difference amount D_{N} is minimized and equal to or less than the threshold B is held as the transmission data.

Note that, in relation to the transmission data, in addition to the image having the minimum difference amount D_{N}, for example, an image having the difference amount D_{N} equal to or more than a predetermined threshold may be stored as the transmission data. One or more images having the difference amount D_{N} equal to or more than a predetermined threshold are required, and one or a plurality of these images may be provided.

<1-6. Situation Analysis Processing>

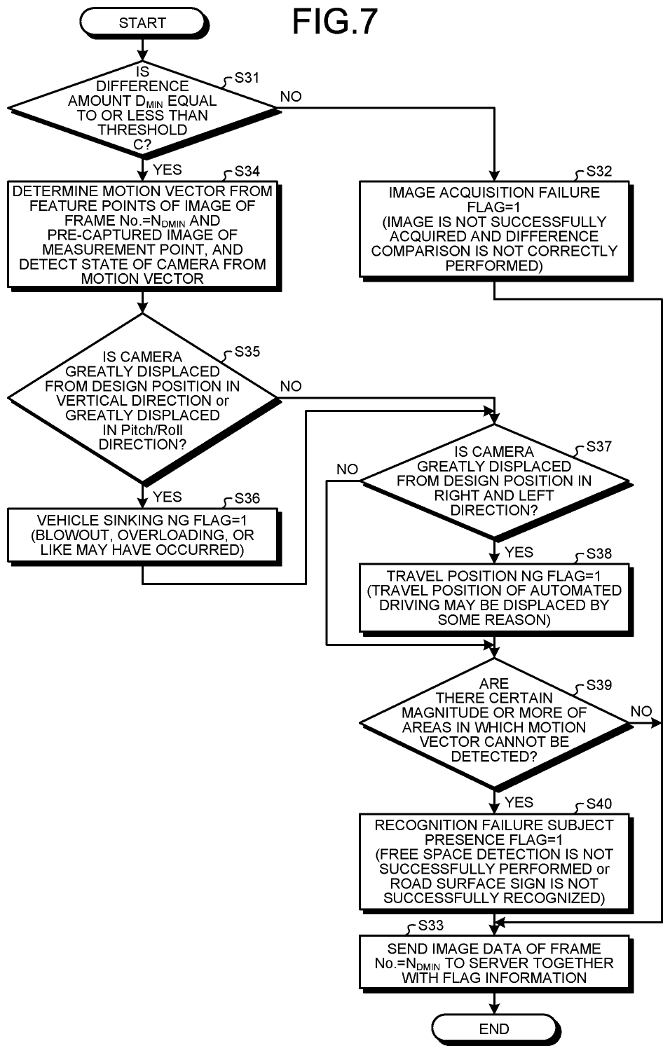

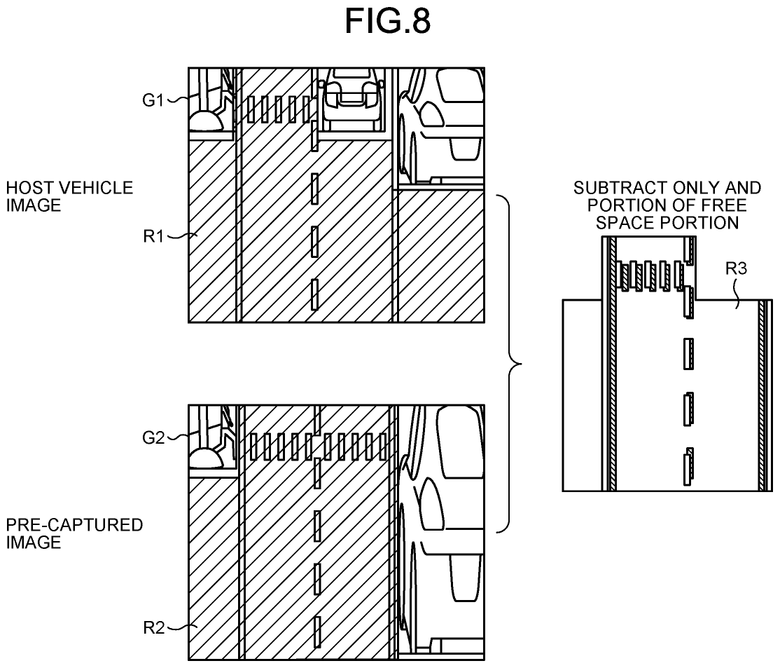

Situation analysis processing according to the first embodiment will be described with reference to FIGS. 7 to 12. FIG. 7 is a flowchart illustrating a flow of situation analysis processing according to the first embodiment. The situation analysis processing corresponds to the processing of Step S9 during the automated driving processing in FIG. 4. FIGS. 8 to 12 are explanatory diagrams for illustrating the situation analysis processing according to the first embodiment.

As illustrated in FIG. 7, the situation analysis unit 15 determines whether or not the difference amount D_{MIN}, which is an amount of difference between the image (host vehicle image) and the pre-captured image is equal to or less than a predetermined threshold C (threshold C<threshold A<threshold B) (Step S31). When determining that the difference amount D_{MIN} is not equal to or less than the predetermined threshold C (NO in Step S31), the situation analysis unit 15 sets image acquisition failure flag=1 (Step S32), and sends an image of frame No.=N_{DMIN} to the server together with flag information (Step S33). The server stores the image (image data) of frame No.=N_{DMIN} in the database 30 together with the flag information. The image acquisition failure flag indicates that an image is not successfully acquired and that difference comparison is not correctly performed.

In contrast, when determining that the difference amount D_{MIN} is equal to or less than the predetermined threshold C (YES in Step S31), the situation analysis unit 15 determines a motion vector from feature points of the image (host vehicle image) of frame No.=N_{DMIN} and the pre-captured image of the measurement point, and detects the state of a camera (imaging device 10) from the motion vector (Step S34). In other words, the situation analysis unit 15 analyzes and detects the situation of the imaging device 10, that is, the situation of the vehicle 20 from the motion vector.

Here, the motion vector is one example of the difference information, and is a difference between a feature point of the host vehicle image and a feature point of the pre-captured image. The movement amount and movement direction of these feature points are obtained as a motion vector. Note that, although a feature point is used as a feature of an image, this is not a limitation. For example, a feature line may be used. Examples of the feature point and the feature line include a lane such as a white line and a yellow line.

The situation analysis unit 15 determines whether or not the camera (imaging device 10) is greatly displaced from a design position (predetermined installation position) in a vertical direction or greatly displaced in a pitch or roll direction based on the motion vector (Step S35). When determining that the camera is greatly displaced from the design position or greatly displaced in the pitch or roll direction based on the motion vector (YES in Step S35), the situation analysis unit 15 sets vehicle sinking NG flag=1 (Step S36), and advances the processing to Step S37. The vehicle sinking NG flag indicates that blowout, overloading, or the like may have occurred.

In contrast, when determining that the camera (imaging device 10) is not greatly displaced from the design position (NO in Step S35), the situation analysis unit 15 determines whether or not the camera is greatly displaced from the design position in a right and left direction (Step S37). When determining that the camera is greatly displaced from the design position (YES in Step S37), the situation analysis unit 15 sets travel position NG flag=1 (Step S38), and advances the processing to Step S39. The travel position NG flag (travel position abnormality flag) indicates that a travel position of automated driving may be displaced by some reason.

Here, in Steps S35 and S37, whether or not the camera is greatly displaced is determined by whether or not the movement amount (displacement amount) based on the motion vector is equal to or more than a predetermined threshold. That is, when the movement amount is equal to or more than the predetermined threshold, the camera is determined to be greatly displaced. When the movement amount is smaller than the predetermined threshold, the camera is determined not to be greatly displaced. Note that, since the movement direction is known in addition to the movement amount, it is possible to determine in which direction the displacement is made.

In contrast, when determining that the camera (imaging device 10) is not greatly displaced from the design position (NO in Step S37), the situation analysis unit 15 determines whether or not there are a certain magnitude or more of areas in which a motion vector cannot be detected (Step S39). When determining that there are a certain magnitude or more of areas in which a motion vector cannot be detected (YES in Step S39), the situation analysis unit 15 sets recognition failure subject presence flag=1 (Step S40), and advances the processing to Step S33. In contrast, when determining that there are not a certain magnitude or more of areas in which a motion vector cannot be detected (NO in Step S39), the situation analysis unit 15 advances the processing straight to Step S33. The recognition failure subject presence flag (recognition failure flag) indicates that free space detection is not successfully performed or that a road surface sign is not successfully recognized.

Note that, in Step S33, the image of Frame No.=N_{DMIN} is sent to the server together with the flag information. The server stores the image (image data) of frame No.=N_{DMIN} in the database 30 together with the flag information. The flag and the image are checked by human eyes or software on the server side. Service that prompts a driver to perform an inspection may be given in accordance with the content.

For example, as illustrated in FIG. 8, a host vehicle image G1 is acquired, and a pre-captured image G2 is read. The host vehicle image G1 is an overhead image, and has free space R1 without an object such as another vehicle and an obstacle. Similarly, the pre-captured image G2 is also an overhead image, and has free space R2 without an object such as another vehicle and an obstacle. The pre-captured image G2 was captured on another day by, for example, another vehicle and a fixed-point camera.

In Step S34 described above, feature points (common features) of the host vehicle image G1 and the pre-captured image G2 are obtained, and a motion vector is obtained from these feature points. Specifically, in the host vehicle image G1 and the pre-captured image G2, only an AND (logical product) region of the free spaces R1 and R2, that is, only a common region is subtracted. First, in the host vehicle image G1 and the pre-captured image G2, common free space (common region) R3 without an object such as another vehicle and an obstacle is obtained. Then, a feature point in the free space R3 of the host vehicle image G1 is obtained. A feature point in the free space R3 of the pre-captured image G2 is obtained. Motion vectors (movement amount and movement direction) of these feature points are calculated.

In the example of FIG. 8, a lane (feature) of the host vehicle image G1 spreads to the right and left in FIG. 8 with respect to a lane (feature) of the pre-captured image G2. That is, the position of the imaging device 10 is lower than the design position. Therefore, in Step S35, a vehicle sinking NG flag is set (vehicle sinking NG flag=1). In this case, blowout may have occurred, or an overload more than expected may be applied to the vehicle 20.

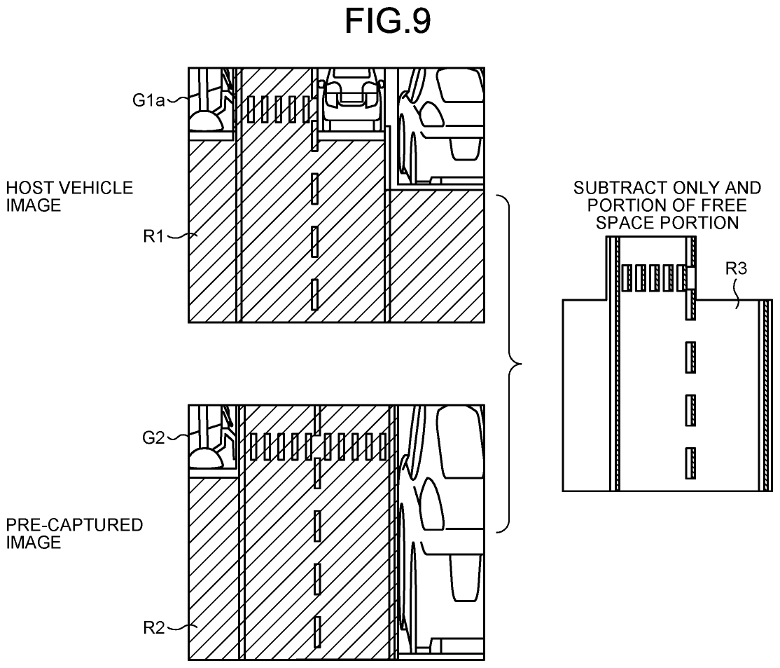

In the example of FIG. 9, a lane of a host vehicle image G1a is displaced to the left side in FIG. 9 with respect to a lane of the pre-captured image G2. That is, the position of the imaging device 10 is displaced to the left side in FIG. 9 with respect to the design position. Therefore, in Step S37, the travel position NG flag is set (travel position NG flag=1). In this case, the travel position of the vehicle 20 is displaced to the left side as compared with that in the pre-captured image G2 to be compared.

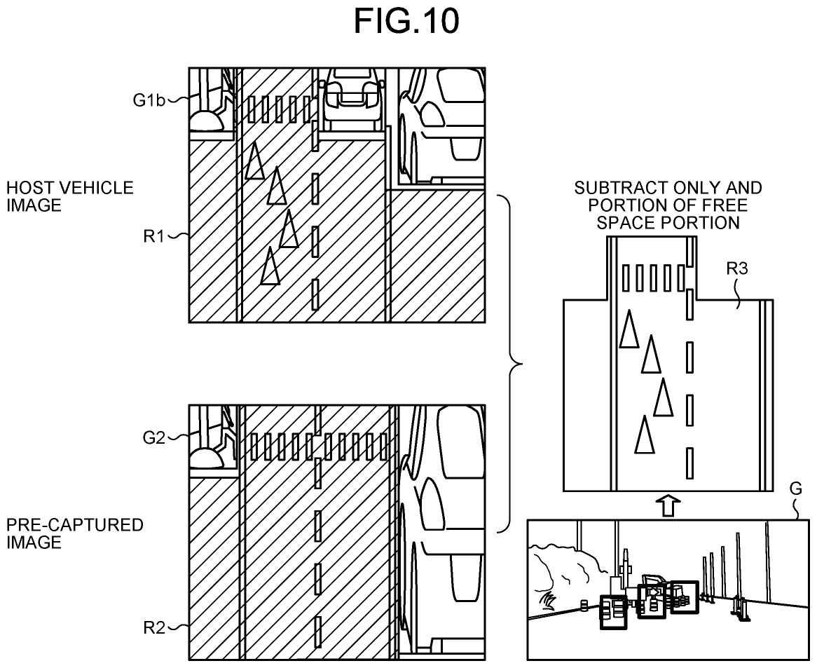

In the example of FIG. 10, a host vehicle image G1b includes an object (Δ mark in FIG. 10) that does not exist in the pre-captured image G2. Therefore, in Step S40, the recognition failure subject presence flag is set (recognition failure subject presence flag=1). In this case, the object (A mark in FIG. 10) is missed in free space detection. For example, an undetectable object (subject) such as a road cone may be placed.

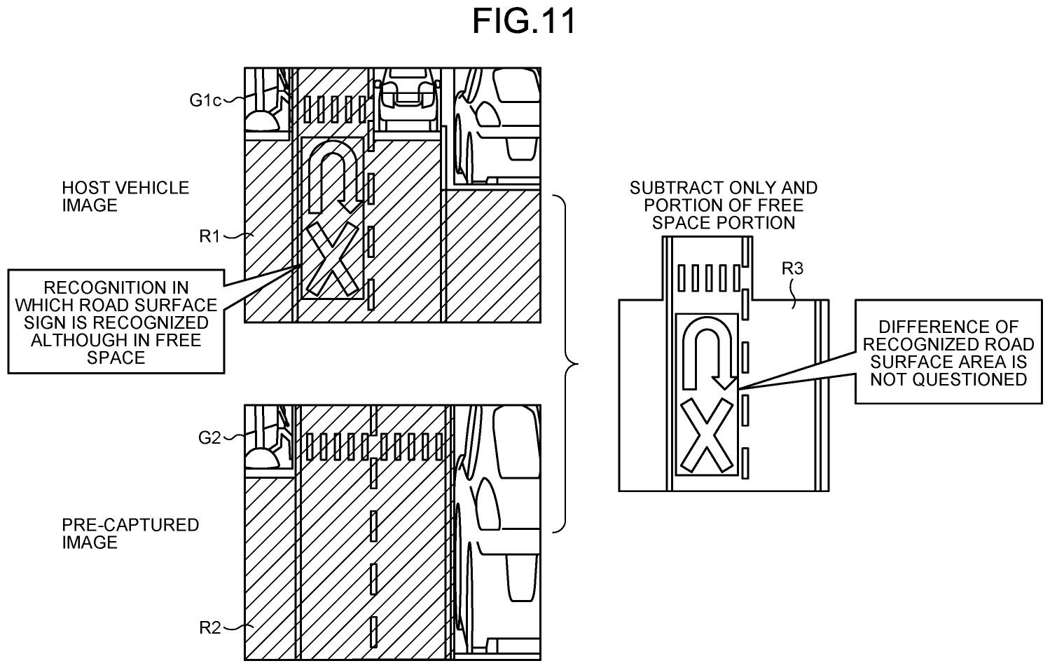

In the example of FIG. 11, a host vehicle image G1c includes an object (road surface sign in FIG. 11) that does not exist in the pre-captured image G2. The road surface sign is recognized in the free space detection. The region of the road surface sign is excluded from difference processing. For example, the image comparison unit 14 recognizes a road surface sign included in the free space R1 by image processing, and executes the difference processing except the region of the road surface sign. The road surface sign does not cause a problem in travel of the vehicle 20.

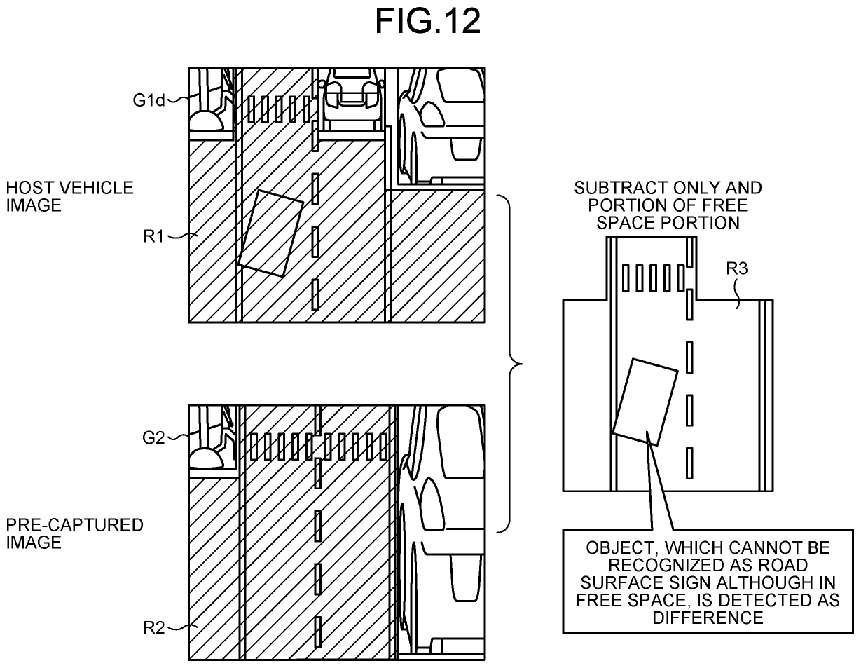

In the example of FIG. 12, a host vehicle image G1d includes an object (rectangle in FIG. 12) that does not exist in the pre-captured image G2. Therefore, in Step S40, the recognition failure subject presence flag is set (recognition failure subject presence flag=1). In this case, the object (rectangle in FIG. 12) is not recognized as a road surface sign by the free space detection. For example, an object (subject) other than a road surface sign may be placed.

<1-7. Processing of Controlling Automated Driving Level>

Processing of controlling (processing of changing) an automated driving level according to the first embodiment will be described. In this control processing, for example, an automated driving level is controlled in accordance with the above-described flags (image acquisition failure flag, vehicle sinking NG flag, travel position NG flag, and recognition failure subject presence flag). For example, when any of the flags is set (flag=1) in a situation where execution of automated driving at Level 3 is permitted, the automated driving level is lowered, and execution of automated driving at Level 3 or higher is prohibited.

When image acquisition failure flag=1 is continuously set at each measurement point, an abnormality may have occurred on the side of a monitoring system of the imaging device 10. Thus, the control unit 16 notifies a driver that there is an abnormality, and switches the automated driving level to a hands-on automated driving level at which the driver holds a steering wheel. For example, the control unit 16 changes the automated driving level from Level 3 to Level 2 or lower. That is, the execution of automated driving at Level 3 or higher is prohibited, and automated driving at Level 2 or lower is permitted (same applies hereinafter).

When vehicle sinking NG flag=1 is set, for example, when a displacement amount is smaller than a certain value, the vehicle 20 automatically travels while having wider distances to front and rear vehicles. In contrast, when the displacement amount is equal to or more than the certain value, the control unit 16 notifies the driver that vehicle sinking has occurred, and switches the automated driving level to the hands-on automated driving level. For example, the control unit 16 changes the automated driving level from Level 3 to Level 2 or lower.

When travel position NG flag=1 is set, the vehicle 20 automatically travels while having wider distances to another vehicle and a wall in a lateral direction. In contrast, when the distances in the lateral direction cannot be secured, the control unit 16 notifies the driver that the distances in the lateral direction cannot be secured, and switches the automated driving level to the hands-on automated driving level. For example, the control unit 16 changes the automated driving level from Level 3 to Level 2 or lower.

When recognition failure subject presence flag=1 is set, the control unit 16 sets the speed to be lowered at the time when another vehicle passes through a measurement point at which the flag is on, and switches the automated driving level to the hands-on automated driving level. For example, the control unit 16 changes the automated driving level from Level 3 to Level 2 or lower.

Note that, on the server side, an image in which the recognition failure subject presence flag is set is preferentially analyzed by human eyes, and the cause is addressed. For example, when the presence of an unrecognizable object or sign on a road is confirmed, the control unit 16 excludes the periphery of the measurement point from routing or, even when the periphery is included in a route, sets the periphery as a hands-on automated driving region until a countermeasure is taken.

Furthermore, when recognition failure subject presence flag=1 is continuously set at each measurement point, an abnormality may have occurred on the side of the monitoring system of the imaging device 10. Thus, the control unit 16 notifies the driver that there is an abnormality, and switches the automated driving level to the hands-on automated driving level. For example, the control unit 16 changes the automated driving level from Level 3 to Level 2 or lower.

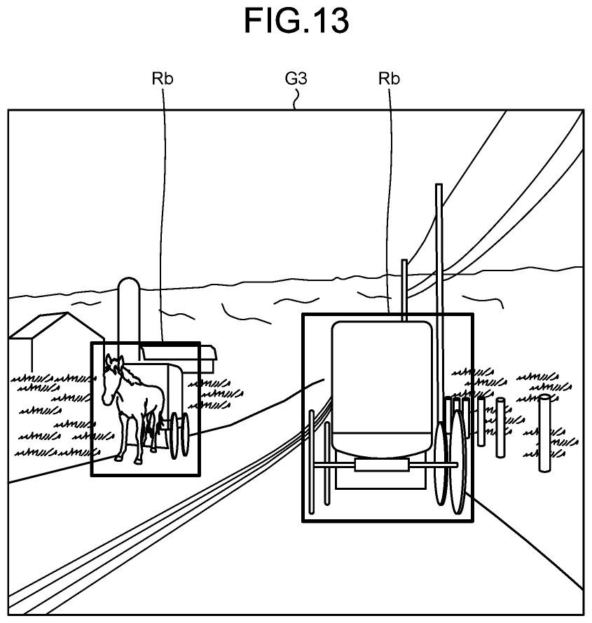

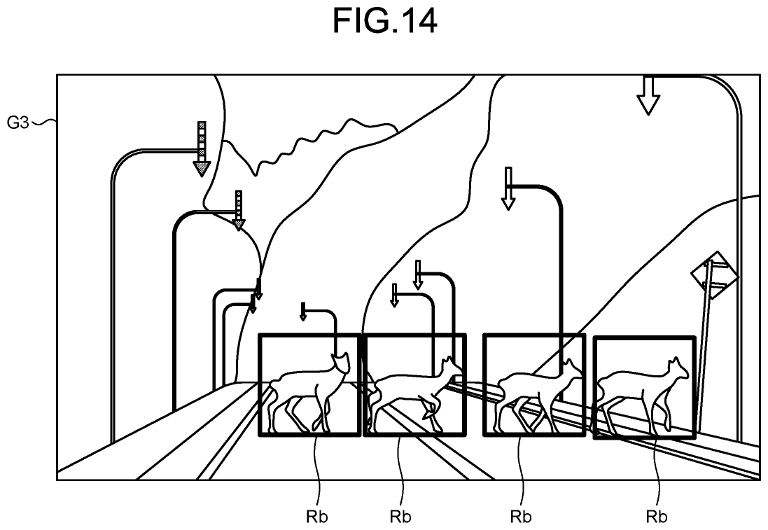

Note that, as illustrated in FIGS. 13 and 14, when an image G3 includes an unrecognizable object (subject), the control unit 16 reports that the image G3 includes an unrecognizable object Rb to the driver, and excludes the route from an operational design domain (ODD) of automated driving. In the example of FIG. 13, the object Rb is a carriage. In the example of FIG. 14, the object Rb is a deer.

Here, execution of automated driving at Level 3 or higher is permitted based on the ODD representing an operation design region. The ODD is a travel environmental condition (various conditions) predicated on actuation of an automated driving system in design. When the travel environmental condition is satisfied, the automated driving system is normally actuated. In contrast, when some condition is not satisfied, automated driving may have difficulty, and thus an operation stop measure or switching to manual driving is required.

The automated driving level is defined in six levels from zero to five by society of automotive engineers (SAE), for example. Specifically, the automated driving level is classified into no driving automation (Level 0), driving assistance (Level 1), partial driving automation (Level 2), conditional driving automation (Level 3), advanced driving automation (Level 4), and fully automated driving (Level 5).

At Level 0 (no driving automation), a main constituent is a driver, and a travel region (travel place) is not limited. At Level 0, the driver executes all dynamic driving tasks.

At Level 1 (driving assistance), the main constituent is the driver, and the travel region is limited. At Level 1, a driving automation system continuously executes a subtask of vehicle motion control in either longitudinal or lateral (not both) direction of the dynamic driving task in a specific limited region. In this case, the driver is expected to execute the remaining dynamic driving task. For example, at Level 1, the vehicle supports any of an accelerator operation, a brake operation, and a steering wheel operation (turn right/left, maintain lane). Specific examples of automated driving functions at Level 1 include adaptive cruise control (ACC) for maintaining a constant following distance, a collision damage reducing brake, lane keeping assist, and garaging and parking assist.

At Level 2 (partial driving automation), the main constituent is the driver, and the travel region is limited. At Level 2, the driving automation system continuously executes the subtask of vehicle motion control in a longitudinal direction and a lateral direction of the dynamic driving task in the specific limited region. In this case, the driver is expected to complete detection and response of an object/event, which are subtasks of the dynamic driving task, and monitor a system. For example, at Level 2, the vehicle simultaneously supports a plurality of operations such as the accelerator operation, the brake operation, and the steering wheel operation. Specific examples of the automated driving function at Level 2 include ACC with steering assist.

At Level 3 (conditional driving automation), the main constituent is the vehicle, and the travel region is limited. At Level 3, the driving automation system continuously executes all dynamic driving tasks in the limited region. In this case, a user ready to respond to a case where continuation of actuation is difficult is expected to appropriately respond not only to a system failure related to a dynamic driving task execution system in a system of another vehicle but to a request of intervention issued by the automated driving system after receiving the request. For example, although, at Level 3, the system performs all driving operations (e.g., acceleration, steering, and braking) only under a specific environment or condition (e.g., on highway and under weather except extreme environments), the driver performs the driving operation upon request from the system in an emergency and the like.

At Level 4 (advanced driving automation), the main constituent is the vehicle, and the travel region is limited. At Level 4, the driving automation system continuously executes all dynamic driving tasks and responses to the case where continuation of work is difficult in the limited region. When the continuation of actuation is difficult, the user is not expected to respond to the request of intervention. For example, at Level 4, the system performs all driving operations (e.g., acceleration, steering, and braking) only under a specific environment or condition (e.g., on highway and under weather except extreme environments), the driver does not address an emergency as long as the condition continues, and is not involved in the driving operation at all.

At Level 5 (full driving automation), the main constituent is the vehicle, and the travel region is not limited. At Level 5, the driving automation system executes all dynamic driving tasks and responses to the case where continuation of work is difficult continuously without limitation (not limited to within limited region). When the continuation of actuation is difficult, the user is not expected to respond to the request of intervention. For example, at Level 5, the driver is unnecessary. The travel region is not limited. Traveling in automated driving is possible on a road in any place.

Note that, although, as described above, the automated driving level is defined in six levels from zero to five, this is not a limitation. For example, the automated driving level may be defined in seven or more or five or less levels Furthermore, the content of each automated driving level can also be changed to a content different from the above-described content, and can be appropriately defined.

<1-8. Image Selection Processing>

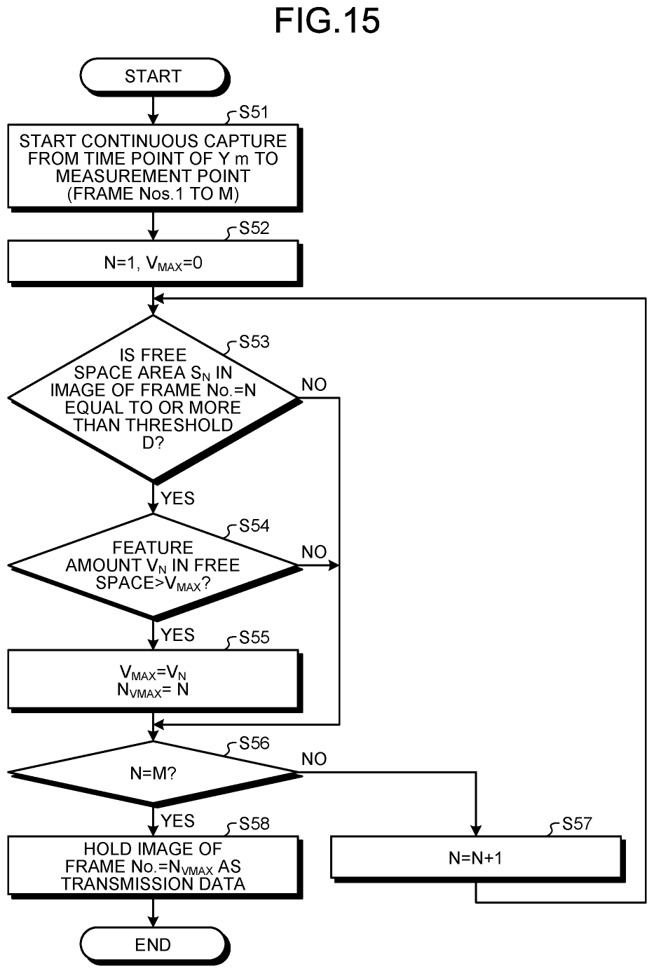

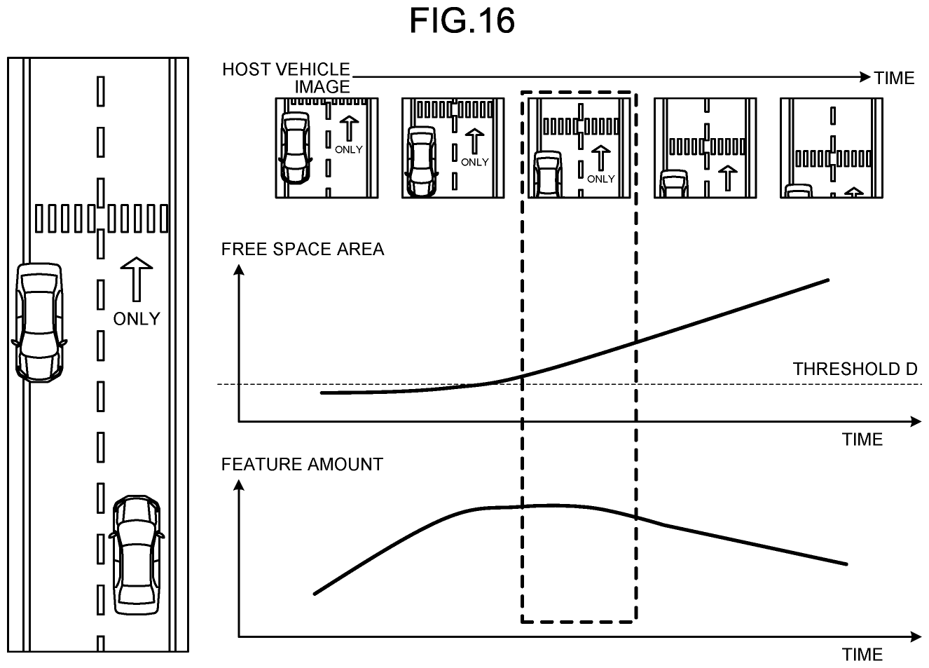

Image selection processing according to the first embodiment will be described with reference to FIGS. 15 and 16. FIG. 15 is a flowchart illustrating a flow of the image selection processing according to the first embodiment. The image selection processing corresponds to the processing of Step S11 during the automated driving processing in FIG. 4. FIG. 16 is an explanatory diagram for illustrating the image selection processing according to the first embodiment.

As illustrated in FIG. 15, the image processing unit 13 starts continuous capture of a host vehicle image from a time point when the vehicle 20 is at a predetermined distance Ym to a measurement point (Step S51), and sets N=1 and V_{MAX}=0 (Step S52). The number of frames is M (frame Nos. 1 to M).

The image comparison unit 14 determines whether or not a free space area S_{N} in an image of frame No.=N (host vehicle image) is equal to or more than a predetermined threshold D (Step S53). When determining that the free space area S_{N} is equal to or more than the predetermined threshold D (YES in Step S53), the image comparison unit 14 determines whether or not a feature amount V_{N} in the free space is larger than V_{MAX} (Step S54). When determining that the feature amount V_{N} in the free space is larger than V_{MAX}, the image comparison unit 14 sets V_{MAX}=V_{N} and N_{VMAX}=N (Step S55).

In contrast, when determining that the free space area S_{N} is not equal to or more than the predetermined threshold D (NO in Step S53) or determining that the feature amount V_{N} in the free space is not larger than V_{MAX} (NO in Step S54), the image comparison unit 14 advances the processing straight to Step S56. Note that the free space area S_{N} and the feature amount V_{N} in the free space are examples of free space information related to the free space.

The image comparison unit 14 determines whether or not N=M is established (Step S56). When determining that N=M is not established (NO in Step S56), the image comparison unit 14 sets N=N+1 (Step S57), and returns the processing to Step S53. In contrast, when determining that N=M is established (YES in Step S56), the image comparison unit 14 holds an image of frame No.=N_{VMAX} as transmission data (Step S58).

For example, in the example of FIG. 16, five (frame Nos. 1 to 5: M=5) host vehicle images are acquired by continuous capture of the host vehicle images. Free space areas S_{N} of these host vehicle images are determined. Feature amounts V_{N} in the free space are determined. An image having a free space area S_{N} of the predetermined threshold D or more and a maximum feature amount V_{N} (central host vehicle image among host vehicle images in FIG. 16) is held as transmission data. This allows the image having a free space area S_{N} of the predetermined threshold D or more and a maximum feature amount V_{N} to be used for image comparison as a pre-captured image. In contrast, when the free space area S_{N} is smaller than the predetermined threshold D, a host vehicle image having the free space area S_{N} is rejected for the transmission data.

Note that, in relation to the transmission data, for example, an image having a free space area S_{N} of a predetermined threshold D or more and a feature amount V_{N} of a predetermined threshold or more may be stored as transmission data in addition to the image having a free space area S_{N} of the predetermined threshold D or more and a maximum feature amount V_{N}. One or more images having the feature amount V_{N} equal to or more than a predetermined threshold are required, and one or a plurality of these images may be provided.

<1-9. Actions/Effects>

As described above, according to the first embodiment, information on the difference between first free space R1 and second free space R2 is acquired. The first free space R1 is provided on a road in the host vehicle image (first image). The host vehicle travels on the road. The second free space R2 is provided on a road in the preliminarily obtained pre-captured image (second image). An automated driving level of the host vehicle is controlled based on the difference information. This allows the difference information to be obtained based on each of free spaces R1 and R2 without an object such as another vehicle and an obstacle, and causes the automated driving level to be controlled based on the difference information. Occurrence of erroneous recognition caused by the presence of the object can thus be inhibited. Control related to automated driving can be appropriately performed.

Furthermore, according to the first embodiment, daily changes (e.g., installation of road surface sign and depression of road) can be addressed by using an actually captured image as a pre-captured image. This allows the difference information to be obtained in response to daily changes, and causes the automated driving level to be controlled based on the difference information. Occurrence of erroneous recognition caused by the daily changes can thus be inhibited. Control related to automated driving can be appropriately performed. Note that, when an image generated by simulation is used as a pre-captured image to be compared, it is difficult to address the daily changes. Erroneous recognition caused by the daily changes may occur.

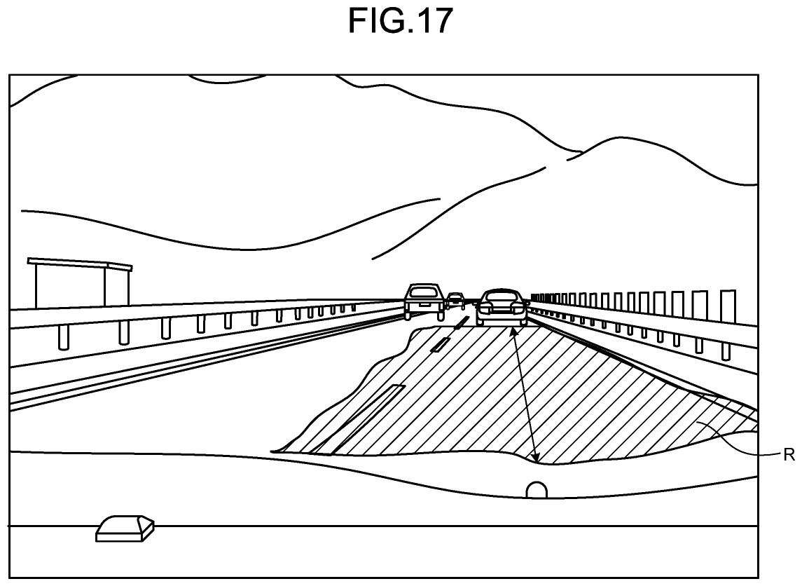

Here, although, in the first embodiment, an example, in which the free spaces R1 and R2 are detected by the image processing unit 13 recognizing an object (subject) in an image and detecting a predetermined region while avoiding the object, has been described, this is not a limitation. For example, as illustrated in FIG. 17, an area in front of the vehicle may be detected as the free space R in accordance with the speed of the vehicle 20. FIG. 17 is an explanatory view for illustrating another example of free space detection according to the first embodiment. In one example, when the speed of the vehicle 20 is 80 km/h, the free space R to a preceding vehicle traveling in front of the host vehicle is 80 m. Note that, in automated driving, usually, a following distance is secured in accordance with the speed of the vehicle 20, so that a certain following distance is provided to the preceding vehicle traveling in front of the host vehicle.

### 2. Second Embodiment

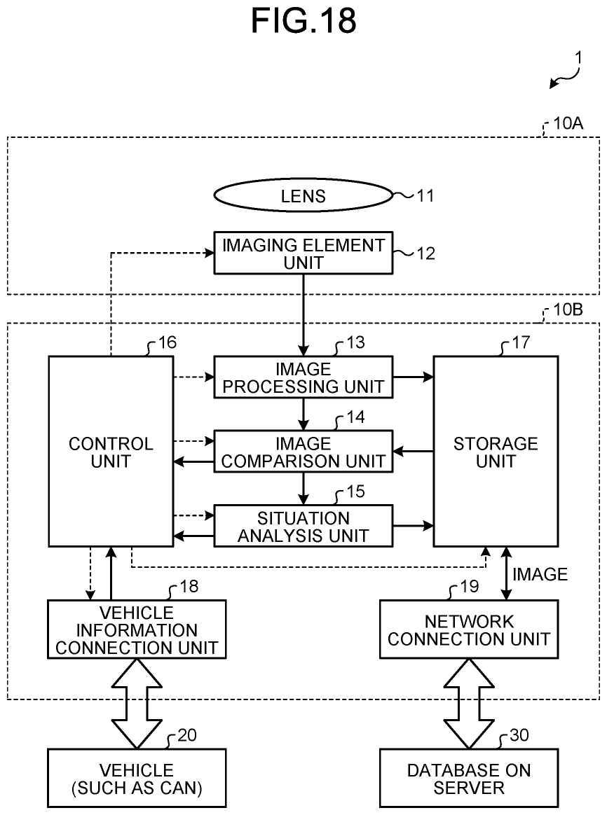

An example of a schematic configuration of an imaging system 1 according to a second embodiment, to which the signal processing device according to the present disclosure is applied, will be described with reference to FIG. 18. FIG. 18 is a block diagram illustrating the example of the schematic configuration of the imaging system 1 according to the second embodiment. Differences from the first embodiment will be mainly described below, and other descriptions will be omitted.

As illustrated in FIG. 18, the imaging system 1 according to the second embodiment includes an imaging device 10A and a processing device 10B. The imaging device 10A includes an optical system 11 and an imaging element unit 12. The processing device 10B includes an image processing unit 13, an image comparison unit 14, a situation analysis unit 15, a control unit 16, a storage unit 17, a vehicle information connection unit 18, and a network connection unit 19. The imaging device 10A and the processing device 10B can communicate with each other by wire or wirelessly. Note that another control unit may be provided in the above-described imaging device 10A.

As described above, according to the second embodiment, the imaging device 10A can be downsized by separating the imaging device 10A and the processing device 10B from each other. This can increase the degree of freedom of installation of the imaging device 10A, and improve the convenience for a user. Note that, according to the second embodiment, the same effects as those of the first embodiment can be obtained.

### 3. Third Embodiment

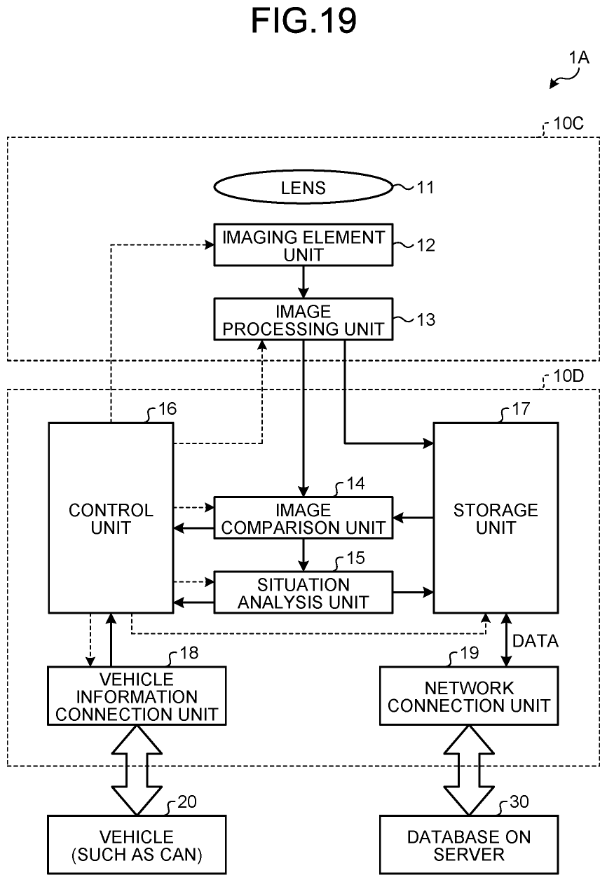

An example of a schematic configuration of an imaging system 1A according to a third embodiment, to which the signal processing device according to the present disclosure is applied, will be described with reference to FIG. 19. FIG. 19 is a block diagram illustrating the example of the schematic configuration of the imaging system 1A according to the third embodiment. Differences from the first embodiment will be mainly described below, and other descriptions will be omitted.

As illustrated in FIG. 19, the imaging system 1A according to the third embodiment includes an imaging device 10C and a processing device 10D. The imaging device 10C includes an optical system 11, an imaging element unit 12, and an image processing unit 13. The processing device 10D includes an image comparison unit 14, a situation analysis unit 15, a control unit 16, a storage unit 17, a vehicle information connection unit 18, and a network connection unit 19. The imaging device 10C and the processing device 10D can communicate with each other by wire or wirelessly. Note that another control unit may be provided in the above-described imaging device 10C.

As described above, according to the third embodiment, the imaging device 10C can be downsized by separating the imaging device 10C and the processing device 10D from each other. This can increase the degree of freedom of installation of the imaging device 10C, and improve the convenience for a user. Note that, according to the third embodiment, the same effects as those of the first embodiment can be obtained.

Note that, although, in the third embodiment, an example in which the image processing unit 13 is provided in the imaging device 10C has been described, this is not a limitation. For example, any one or a plurality of the image comparison unit 14, the situation analysis unit 15, the control unit 16, and the storage unit 17 may be provided in the imaging device 10C. That is, the image processing unit 13, the image comparison unit 14, the situation analysis unit 15, the control unit 16, and the storage unit 17 can be appropriately distributed and provided to the imaging device 10C and the processing device 10D.

### 4. Other Embodiments

Although, in each of the above-described embodiments, an example in which a host vehicle image and a pre-captured image are compared in one frame in accordance with a measurement point has been described, this is not a limitation. For example, the host vehicle image and the pre-captured image may be compared in a plurality of continuous frames including the front and rear of a measurement point. In this case, each pre-captured image corresponding to the front and rear of the measurement point is also preliminarily stored.

Furthermore, although, in each of the above-described embodiments, an example in which an automated driving level is controlled based on the difference information has been described, this is not a limitation. For example, the control unit 16 may control any one or both of the speed and a following distance (separation distance between host vehicle and another vehicle) of the host vehicle based on the difference information. In this case, in addition to the automated driving level, any one or both of the speed and the following distance of the host vehicle can be controlled. Alternatively, any one or both of the speed and the following distance of the host vehicle can be independently controlled.

Furthermore, although, in each of the above-described embodiments, an example in which the imaging device 10 executes free space detection (the free space detection includes, for example, recognition of an obstacle and a road surface sign) has been described, this is not a limitation. For example, another camera may execute the free space detection. In this case, a detection result (recognition result) detected by the other camera is transmitted to the imaging device 10 together with camera position information. Furthermore, for the free space detection, a detection device other than a camera, such as light detection and ranging or laser imaging detection and ranging (LiDAR) and a radar can be used.

Furthermore, although, in each of the above-described embodiments, an example in which a pre-captured image to be compared is received at the timing when the vehicle 20 approaches a predetermined point (corresponding point) (position of predetermined distance from measurement point) has been described, this is not a limitation. For example, the pre-captured image may be preliminarily received by downloading at the time of routing (route setting) before traveling. Comparison processing can be performed even in a place where radio waves do not arrive and cannot be received, such as a tunnel, by preliminarily receiving the pre-captured image.

Furthermore, in relation to routing, a route having a pre-captured image may be preferentially selected to perform routing. Furthermore, the pre-captured image may be captured by another vehicle. The pre-captured image may be received from a server, or may be received from an on-road device that accumulates pre-captured images. When the route is a road often passed through, road deterioration and the like can be accurately detected by storing a host vehicle image as a pre-captured image and using the host vehicle image as a comparison target. For a lane (e.g., white line) in an image, the difference may be got as it is by image comparison. Alternatively, when the lane is unnecessary, the lane may be recognized, masked, and excluded from the comparison target. In a case of a three-dimensional object or a road surface sign for which difference of a comparison result cannot be recognized, the image may be transmitted to the server and used as teacher data for learning so that a machine learning system can recognize the image.

Furthermore, in order to monitor the state of the host vehicle more accurately, the above-described imaging device 10 can be applied not only to a camera facing forward but also to a camera facing sideward or rearward. Furthermore, the imaging device 10 can be applied to an electronic device other than a camera, for example, a drive recorder, a mobile terminal, and the like. This electronic device is attached to the vehicle 20.

Although the embodiments of the present disclosure have been described above, the technical scope of the present disclosure is not limited to the above-described embodiments as it is, and various modifications can be made without departing from the gist of the present disclosure. Furthermore, components of different embodiments and variations may be appropriately combined.

Furthermore, effects in each embodiment described in the specification are merely examples and not limitations. Other effects may be exhibited.

### 5. Appendix

Note that the present technology can also have the configurations as follows.
(1)

A signal processing device comprising:
an image comparison unit that acquires difference information between first free space on a road, in which a vehicle travels, in a first image and second free space on the road in a preliminarily obtained second image; and
a control unit that controls an automated driving level of the vehicle based on the difference information.

(2)

The signal processing device according to (1), further comprising
an image processing unit that detects the first free space from the first image and the second free space from the second image.

(3)

The signal processing device according to (1) or (2),
wherein the first free space and the second free space include a common region; and
the difference information includes an amount of difference between the common region of the first free space and the common region of the second free space.

(4)

The signal processing device according to any one of (1) to (3), further comprising
a situation analysis unit that analyzes a situation of the vehicle based on the difference information,
wherein the control unit controls an automated driving level of the vehicle in accordance with the situation of the vehicle.

(5)

The signal processing device according to (4),
wherein the first free space and the second free space include a common feature, and
the difference information includes a movement amount and a movement direction of the common feature of the first free space and the common feature of the second free space.

(6)

The signal processing device according to (4) or (5),
wherein the situation analysis unit analyzes an acquisition failure of the first image, sinking of the vehicle, a travel position abnormality of the vehicle, or a recognition failure of the first image as a situation of the vehicle, and
the control unit lowers an automated driving level of the vehicle when the situation analysis unit recognizes the acquisition failure of the first image, the sinking of the vehicle, the travel position abnormality of the vehicle, or the recognition failure of the first image.

(7)

The signal processing device according to any one of (1) to (6),
wherein the control unit shifts an automated driving level of the vehicle to a measurement automated driving level for acquiring the first image when the vehicle is located at a predetermined distance from an image acquisition point at which the first image is acquired.

(8)

The signal processing device according to (7),
wherein the control unit shifts the measurement automated driving level of the vehicle to an original automated driving level of the vehicle when there is no second image corresponding to the image acquisition point at which the first image is acquired.

(9)

The signal processing device according to any one of (1) to (8),
wherein the image comparison unit repeatedly captures the first image from an image acquisition point at which the first image is acquired from a certain time point when the vehicle is located at a predetermined distance, and selects and uses one or more first images from a plurality of captured first images.

(10)

The signal processing device according to (9),
wherein the image comparison unit
acquires an individual piece of difference information between the plurality of captured first images and the second image, and
selects one or more first images from the plurality of captured first images based on the acquired individual piece of difference information.

(11)

The signal processing device according to (10),
wherein each individual piece of difference information is an amount of difference between the first free space and the second free space, and
the image comparison unit selects one or more first images having the amount of difference of a predetermined threshold or more.

(12)

The signal processing device according to any one of (9) to (11),
wherein the image comparison unit stores one or more used first images as the second image.

(13)

The signal processing device according to any one of (1) to (12),
wherein the image comparison unit repeatedly captures the first image from an image acquisition point at which the first image is acquired from a certain time point when the vehicle is located at a predetermined distance, and selects and stores one or more first images from a plurality of captured first images.

(14)

The signal processing device according to (13),
wherein the image comparison unit
acquires free space information on the first free space for each of the captured first images, and
selects one or more first images from the plurality of captured first images based on the free space information acquired for each of the first images.

(15)

The signal processing device according to (14),
wherein each piece of free space information for each of the first images is an area of the first free space, and
the image comparison unit selects one or more first images having the area of a predetermined threshold or more.

(16)

The signal processing device according to (14) or (15),
wherein each piece of free space information for each of the first images is a feature amount of the first free space, and
the image comparison unit selects one or more first images having the feature amount of a predetermined threshold or more.

(17)

The signal processing device according to any one of (1) to (16),
wherein the image comparison unit acquires the difference information except a region of a road surface sign included in the first free space.

(18)

The signal processing device according to any one of (1) to (17),
wherein the first image and the second image are overhead images obtained from a predetermined virtual viewpoint.

(19)

The signal processing device according to any one of (1) to (18),
wherein the control unit controls any one or both of a speed and a following distance of the vehicle.

(20)

A signal processing method comprising:
acquiring difference information between first free space on a road, in which a vehicle travels, in a first image and second free space on the road in a preliminarily obtained second image; and
controlling an automated driving level of the vehicle based on the difference information.

(21)

A signal processing method using the signal processing device according to any one of (1) to (19).

### REFERENCE SIGNS LIST

1 IMAGING SYSTEM
1A IMAGING SYSTEM
10 IMAGING DEVICE
11 OPTICAL SYSTEM
12 IMAGING ELEMENT UNIT
13 IMAGE PROCESSING UNIT
14 IMAGE COMPARISON UNIT
15 SITUATION ANALYSIS UNIT
16 CONTROL UNIT
17 STORAGE UNIT
18 VEHICLE INFORMATION CONNECTION UNIT
19 NETWORK CONNECTION UNIT
20 VEHICLE
30 DATABASE
G IMAGE
Ga OVERHEAD IMAGE
G1 HOST VEHICLE IMAGE
G1a to G1d HOST VEHICLE IMAGE
G2 PRE-CAPTURED IMAGE
G3 IMAGE
R FREE SPACE
Ra FREE SPACE
R1 to R3 FREE SPACE

1. A signal processing device comprising:
an image comparison unit that acquires difference information between first free space on a road, in which a vehicle travels, in a first image and second free space on the road in a preliminarily obtained second image; and
a control unit that controls an automated driving level of the vehicle based on the difference information.

2. The signal processing device according to claim 1, further comprising
an image processing unit that detects the first free space from the first image and the second free space from the second image.

3. The signal processing device according to claim 1,
wherein the first free space and the second free space include a common region; and
the difference information includes an amount of difference between the common region of the first free space and the common region of the second free space.

4. The signal processing device according to claim 1, further comprising
a situation analysis unit that analyzes a situation of the vehicle based on the difference information,
wherein the control unit controls an automated driving level of the vehicle in accordance with the situation of the vehicle.

5. The signal processing device according to claim 4,
wherein the first free space and the second free space include a common feature, and
the difference information includes a movement amount and a movement direction of the common feature of the first free space and the common feature of the second free space.

6. The signal processing device according to claim 4,
wherein the situation analysis unit analyzes an acquisition failure of the first image, sinking of the vehicle, a travel position abnormality of the vehicle, or a recognition failure of the first image as a situation of the vehicle, and
the control unit lowers an automated driving level of the vehicle when the situation analysis unit recognizes the acquisition failure of the first image, the sinking of the vehicle, the travel position abnormality of the vehicle, or the recognition failure of the first image.

7. The signal processing device according to claim 1,
wherein the control unit shifts an automated driving level of the vehicle to a measurement automated driving level for acquiring the first image when the vehicle is located at a predetermined distance from an image acquisition point at which the first image is acquired.

8. The signal processing device according to claim 7,
wherein the control unit shifts the measurement automated driving level of the vehicle to an original automated driving level of the vehicle when there is no second image corresponding to the image acquisition point at which the first image is acquired.

9. The signal processing device according to claim 1,
wherein the image comparison unit repeatedly captures the first image from an image acquisition point at which the first image is acquired from a certain time point when the vehicle is located at a predetermined distance, and selects and uses one or more first images from a plurality of captured first images.

10. The signal processing device according to claim 9,
wherein the image comparison unit
acquires an individual piece of difference information between the plurality of captured first images and the second image, and
selects one or more first images from the plurality of captured first images based on the acquired individual piece of difference information.

11. The signal processing device according to claim 10,
wherein each individual piece of difference information is an amount of difference between the first free space and the second free space, and
the image comparison unit selects one or more first images having the amount of difference of a predetermined threshold or more.

12. The signal processing device according to claim 9,
wherein the image comparison unit stores one or more used first images as the second image.

13. The signal processing device according to claim 1,
wherein the image comparison unit repeatedly captures the first image from an image acquisition point at which the first image is acquired from a certain time point when the vehicle is located at a predetermined distance, and selects and stores one or more first images from a plurality of captured first images.

14. The signal processing device according to claim 13,
wherein the image comparison unit
acquires free space information on the first free space for each of the captured first images, and
selects one or more first images from the plurality of captured first images based on the free space information acquired for each of the first images.

15. The signal processing device according to claim 14,
wherein each piece of free space information for each of the first images is an area of the first free space, and
the image comparison unit selects one or more first images having the area of a predetermined threshold or more.

16. The signal processing device according to claim 14,
wherein each piece of free space information for each of the first images is a feature amount of the first free space, and
the image comparison unit selects one or more first images having the feature amount of a predetermined threshold or more.

17. The signal processing device according to claim 1,
wherein the image comparison unit acquires the difference information except a region of a road surface sign included in the first free space.

18. The signal processing device according to claim 1,
wherein the first image and the second image are overhead images obtained from a predetermined virtual viewpoint.

19. The signal processing device according to claim 1,
wherein the control unit controls any one or both of a speed and a following distance of the vehicle.

20. A signal processing method comprising:
acquiring difference information between first free space on a road, in which a vehicle travels, in a first image and second free space on the road in a preliminarily obtained second image; and
controlling an automated driving level of the vehicle based on the difference information.
